(19) United States
(12) Patent Application Publication
(10) Pub. No.: US 2016/0101510 A1
(43) Pub. Date: Apr. 14, 2016

(54) INTEGRATED WRENCH STRUCTURE FOR PREVENTING DEPARTED WORKPIECES

(71) Applicant: YEO-MING WANG, TAIPEI CITY (TW)

(72) Inventor: YEO-MING WANG, TAIPEI CITY (TW)

(21) Appl. No.: 14/513,966

(22) Filed: Oct. 14, 2014

(51) Int. Cl. B25B 23/10; B25B 13/46

(52) U.S. Cl. CPC B25B 23/108; B25B 13/463

(57) ABSTRACT

An integrated wrench structure for preventing departed workpieces comprises: a wrench head, which has a hollow operating accommodating space, a peripheral wall of the operating accommodating space has an operating surface, which has a combination of arc surface, curved surface or straight surface, a top end portion is above the wrench head, a top protruding portion of the top end portion circularly protrudes toward the center of the operating accommodating space, the top protruding portion forms an urging ring space that is internally protruded toward the center of the operating accommodating space and is above the operating accommodating space, the top protruding porting is a shielding limit of the operating accommodating space, the top protruding portion is the integrated portions of the wrench head. Therefore, by means of the simple wrench structure, the conveniences of manufacturing and assembling and the business benefits can be approached.

### BACKGROUND OF THE INVENTION

1. Field of the Invention

The present invention generally relates to a wrench structure, more particularly to an integrated wrench structure for preventing departed workpieces that is easily assembled and makes more business benefits.

2. Description of the Prior Art

Wrench is a regular tool for tightening and loosening threaded rod, nut, etc., and there are many types of wrenches, such as open-end wrenches, composite wrenches, offset wrenches, adjustable wrenches, socket wrenches, etc. Generally speaking, a prior wrench structure has a head portion and a handle portion; the head portion has an accommodating room in order to accommodate workpieces (threaded rod or nut). After the accommodating room is engaged with a workpiece, a force is applied to the handle portion in order to tighten or loosen the workpiece. Although prior wrench structure is able to transform a smaller force into a bigger force for tough works, some shortcomings still exist. For instance, if the accommodating room does not match with the workpiece or the angle of applying forces is incorrect, the head portion may be easily departed from workpieces, and the working progress may repeatedly re-apply, which wastes labor time. Further, imposing greater force may easily cause the head portion to slip from a workpiece, and it might consequently possible to hurt hands.

Prior arts related to prevent malposition of a wrench while handling workpieces are disclosed, one of which is a patent of Republic of China No. 483367. The patent is referred as an improved wrench structure and mainly comprises: a wrench, a rotation member, an upper cover, and a ring member. The applying end of the wrench has an accommodating hole that is for accommodating the rotation member, and a side surface of the accommodating hole and the upper cover has a latching slot; a peripheral of the rotation member has matching tooth, and the center of the rotation member is equipped with a polygonal slot; the upper cover is designed to cover the accommodating hole of the wrench, while a ring slot on the upper cover is corresponded to the latching slot; another latching surface is located above the ring slot and is smaller than the polygonal slot of the rotation member; a ring member is female-connected between the latching slot of the wrench and the ring slot of the upper cover, so that the upper cover is positioned to or is pivotally connected with the wrench via the ring member. Although, the prior art patent No. 483367 is able to prevent a screwed member from departing off the wrench by means of the latching surface of the upper cover, as the upper cover is fixed through the ring slot with the latching slot of the wrench and the ring member, it is obvious that the elements are very complicated and manufacturing costs will be definitely high.

Another prior art is Patent No. 494830, thereby provides an improved ratchet wrench structure for preventing departure and mainly comprises: a ratchet wrench with an applying end as an accommodating hole for accommodating the upper and lower ring member of the ratchet, and a ring slot around the top end of the accommodating hole for pivotally connecting with the upper ring member. A peripheral of the ratchet has plurality of matching tooth, and the center of the ratchet is equipped with a polygonal slot. Each of the upper and lower ring members of the ratchet has an embedding end, and the two embedding ends are fixed to an upper end surface and a lower end surface of the ratchet respectively; further, the two embedding ends protrude into the polygonal slot of the ratchet and are staggered. As disclosed in Patent No. 494830, while the ratchet wrench is in a normal/reverse operation, the upper and lower ring members of the ratchet are to latch with the ratchet wrench for prevent departing. However, the cooperation of the ring slot in the accommodating hole and the upper and lower ring members is still complicated and manufacturing costs of the ratchet wrench will be definitely high. And also, the embedding ends of the two ring slots are easily deformed or compressed inwardly to damage the appearance. Therefore, how to solve aforesaid shortcomings is an important issue to the people skilled in the art.

Accordingly, the inventor has studied related prior arts to develop an integrated wrench structure for preventing departed workpieces in order to improve stability and reliability of products, and to promote competitiveness.

### SUMMARY OF THE INVENTION

The main objective of the present invention is to provide an integrated wrench structure for preventing departed workpieces, and the wrench structure is a simple and convenient structure for manufacturing and assembling, so as to realize a great amount of business benefits.

The second objective of the present invention is to provide an integrated wrench structure for preventing departed workpieces, and the wrench structure is able to improve stability and reliability of products, so as to promote competitiveness.

To approach aforesaid objectives, an integrated wrench structure for preventing departed workpieces comprises: a wrench head, with a hollow operating accommodating space, a peripheral wall of the operating accommodating space with an operating surface, which has a combination of arc surface, curved surface or straight surface; a rear end of the wrench head connects with a wrench handle portion, and the top end portion is above the wrench head; a top protruding portion of the top end portion circularly protrudes toward the center of the operating accommodating space, and the tap protruding portion forms an urging ring space that is internally protruded toward the center of the operating accommodating space, and is above the operating accommodating space, the top protruding portion is a shielding limit of the operating accommodating space, and the top protruding portion is the integrated portions of the wrench head.

The third objective of the present invention is to provide an integrated wrench structure for preventing departed workpieces, and is able to simply provide a female-connected member that matches with workpieces in dimensions without changing the whole set of wrench structure while working on a plurality of workpieces with different dimensions (threaded rod or nut), so as to add business benefits.

To approach aforesaid objective, an integrated wrench structure for preventing departed workpieces comprises: a wrench head, which has a hollow operating accommodating space; a female-connecting member, which is separatable and located in the operating accommodating space with a hollow ring shape. The female-connecting member has a female connecting accommodating space, and an inner side of the female-connecting member has an operating surface. The operating surface is with a combination of arc surface, curved surface or straight surface. The female-connecting member is located in the operating accommodating space of the wrench head; a top end portion is above the wrench head, and a top protruding portion of the top end portion circularly protrudes toward the center of the operating accommodating space and the female-connecting member accommodating space, the top protruding portion forms an urging ring space that is internally protruded toward the center of the female-connecting member accommodating space and is above the female-connecting member accommodating space. The top protruding portion is a shielding limit of the female-connecting member accommodating space, and the top protruding portion is the integrated portions of the wrench head.

Accordingly, the female-connecting member has an outer gear ring portion.

Accordingly, the wrench structure further has a positioning member that is stucked in a embedded ring groove under the operating accommodating space. One punch hole is located at the ring on each side of the positioning member.

To reach above objectives, an integrated wrench structure for preventing departed workpieces comprises: a wrench head, which has a hollow operating accommodating space, and a rear portion of the wrench head comes with a first pivotal slot. The first pivotal slot is connected with the operating accommodating space via a horizontal control space, with a rear end of the wrench head connecting with a wrench handle portion; a latching member, which is located in the control space; a reversing switch, which is located in the first pivotal slot, and an urging spring that is in the reversing switch and is against the latching member; a ratchet member, which is located in the operating accommodating space and has a ratchet member accommodating space, an outer side of the ratchet member and the latching member links with each other.

Accordingly, a top end portion is above the wrench head, a top protruding portion of the top end portion protrudes circularly toward the center of the operating accommodating space and the ratchet member accommodating space, the top protruding portion forms an urging ring space that is internally protruded toward the center of the ratchet member accommodating space and is above the ratchet member accommodating space, the top protruding portion is a shielding limit of the ratchet member accommodating space, and the top protruding portion is the integrated portions of the wrench head. Accordingly, a second pivotal slot with a smaller diameter than the first pivotal slot is below the first pivotal slot, and a rear end wall of the first pivotal slot is set with an urging slot.

Accordingly, a front end surface of the latching member is a gear portion; and a rear end surface of the latching member is a latching slot; the gear portion is shaped as an inner arc.

Accordingly, an upper portion of the reversing switch is a twisting member and a lower portion of the reversing switch is a positioning pillar; the positioning pillar is located at the second pivotal slot.

Accordingly, a front surface of the reversing switch has a spring slot that accommodates the urging spring.

Accordingly, the front and rear portions of the urging spring may be equipped with denser springs, and the middle portion of the urging spring may have looser springs.

Accordingly, the ratchet member has an outer gear portion and an inner operating surface.

Accordingly, the diameter of the urging ring space is smaller than the diameter of the ratchet member accommodating space.

Accordingly, the wrench structure further has a support ring member that is located in the operating accommodating space and is female-connected under the gear portion of the ratchet member.

Accordingly, the wrench structure further has a positioning member that is embedded in a ring slot in order to urge and support the support ring member, wherein each of two ends of the positioning member has a ring with a through hole.

### BRIEF DESCRIPTION OF THE DRAWINGS

The objectives, spirit, and advantages of the preferred embodiments of the present invention will be readily understood by the accompanying drawings and detailed descriptions, wherein:

FIG. 1 illustrates a schematic 3-dimensional view of a first preferred embodiment of the present invention;

FIG. 2 illustrates a schematic sectional view of operation of the first preferred embodiment of the present invention;

FIG. 3 illustrates a schematic exploded view of a second preferred embodiment of the present invention;

FIG. 4 illustrates a schematic sectional view of operation of the second preferred embodiment of the present invention;

FIG. 5 illustrates a schematic 3-dimensional view of a third preferred embodiment of the present invention;

FIG. 6 illustrates a schematic exploded view of the third preferred embodiment of the present invention; and

FIG. 7 illustrates a schematic sectional view of operation of the third preferred embodiment of the present invention.

### DETAILED DESCRIPTION OF THE PREFERRED EMBODIMENTS

Following preferred embodiments and figures will be described in details so as to achieve aforesaid objectives.

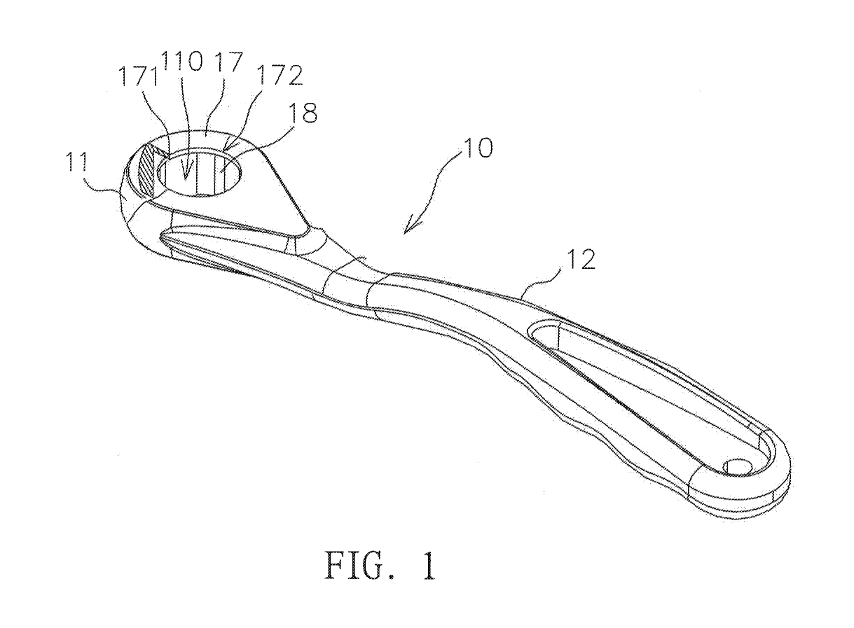

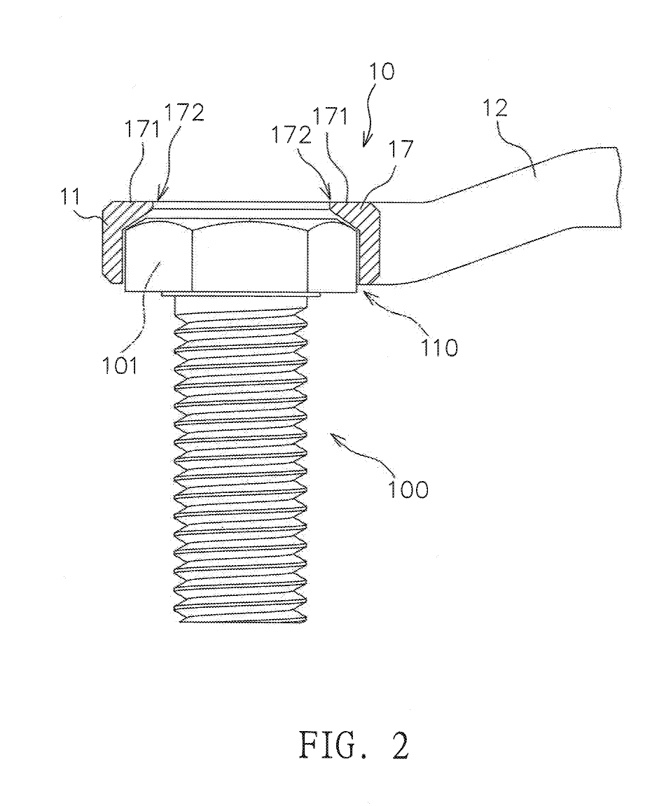

Please refer to FIG. 1 and FIG. 2, which illustrate a schematic 3-dimensional view of a first preferred embodiment of the present invention and a schematic sectional view of operation of the first preferred embodiment of the present invention. An integrated wrench structure for preventing departed workpieces provided by the present invention has a wrench 10. The wrench 10 further has a wrench head 11 and a wrench handle portion 12. The wrench head 11 has a hollow operating accommodating space 110. A peripheral wall of the operating accommodating space 110 has an operating surface 18. A top end portion 17 is above the wrench head 11; a top protruding portion 171 of the top end portion 17 circularly protrudes toward the center of the operating accommodating space 110; the top protruding portion 171 forms an urging ring space 172 that is internally protruded toward the center of the operating accommodating space 110 and is above the operating accommodating space 110; the top protruding portion 171 is a shielding limit of the operating accommodating space 110. The top end portion 17 is a top part of the wrench head 11, and is integrated with the wrench head 11 as well. In other words, the top protruding portion 171 is the integrated portions of the wrench head 11.

If a workpiece, such as threaded rod, nut, etc., is set in the operating accommodating space 110 of the wrench head 11, the top protruding portion 171 of the wrench head 11 is able to cover the head 101 of the workpiece 100 in order to prevent the head of the workpieces101 from detaching off the urging ring space 172. There is one thing to be noted, that is, the structure for preventing departed workpieces provided by the present invention is simple, difficult to break or to be deformed, so as to prevent breaking away.

As aforesaid structure, the operating surface 18 is formed by arc surface, curved surface or straight surface, but not limited thereof.

As aforesaid structure, the diameter of the urging ring space 172 is smaller than the diameter of the operating accommodating space 110, so as to realize the block function of the protruding portion 171.

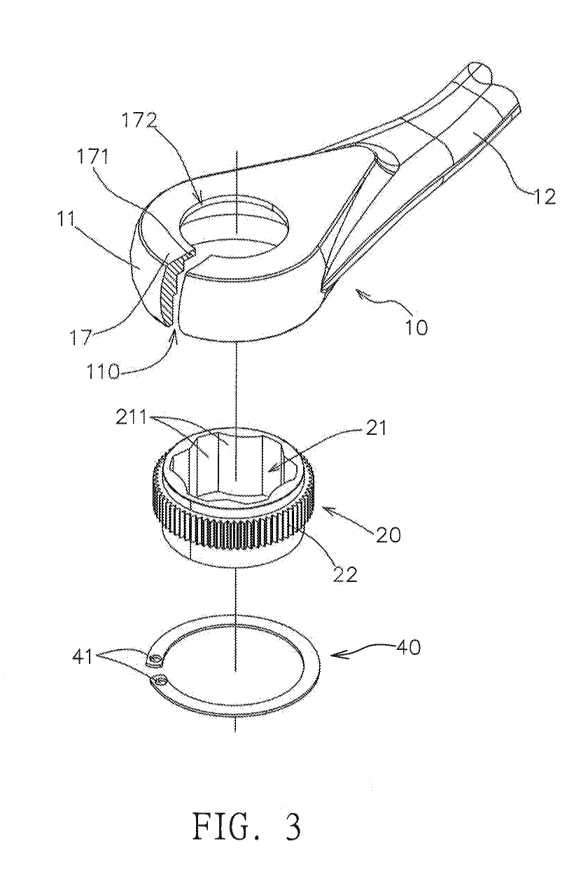

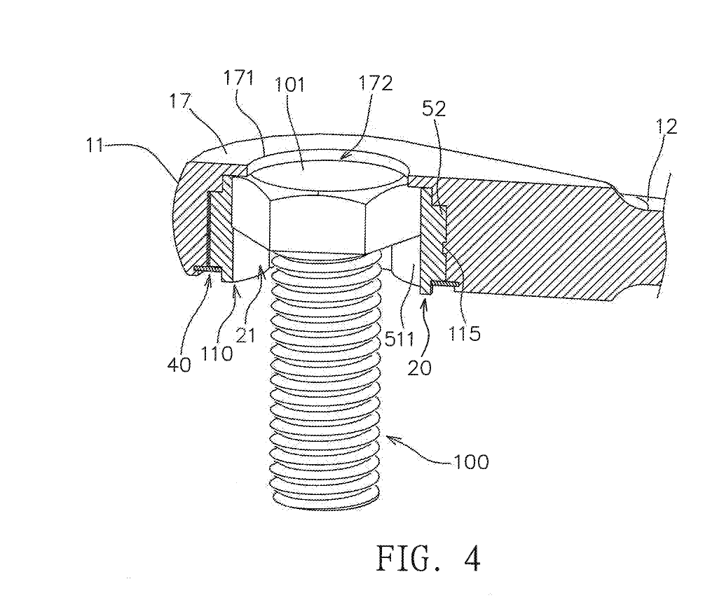

Please refer to FIG. 3 and FIG. 4, which illustrates a schematic exploded view of a second preferred embodiment of the present invention and a schematic sectional view of operation of the second preferred embodiment of the present invention. The second preferred embodiment is another application extended from the first preferred embodiment; therefore the wrench is able to adapted to multiple sizes of workpieces. The wrench 10 comprises: a wrench head 11, which has a hollow operating accommodating space 110, a ring slot 113 is set at the bottom of the operating accommodating space 110, a rear end of the wrench head 11 is connecting with a wrench handle portion 12; a female-connecting member 20 is separatable and located in the operating accommodating space 110 and is as a hollow body of the female-connecting member accommodating space 21; an inner side of the female-connecting member 20 is set with an operating surface 211; a top end portion 17 is above the wrench head 11, a top protruding portion 171 of the top end portion 17 circularly protrudes toward the center of the operating accommodating space 110 and the female-connecting accommodating space 21. The top protruding portion 171 forms an urging ring space 172 that is internally protruded toward the center of the female-connecting member accommodating space 21, and is above the operating accommodating space 110. The top protruding portion 171 is a shielding limit of the female-connecting member accommodating space 21, and the top protruding portion 171 is the integrated portions of the wrench head 11, while the top end of the female-connection member 20 is covered by the top protruding portion 171 of the wrench head 11.

As aforesaid structure, the diameter of the urging ring space 172 is smaller than the diameter of the female-connecting member accommodating space 21, so as to realize the block function of the urging ring space 172.

As aforesaid structure, the female-connecting member 20 has an outer gear ring portion 22.

As aforesaid structure, the female-connecting member 20 is a ratchet member, but not limited thereto.

As aforesaid structure, the operating surface 211 is with a combination of arc surface, curved surface or straight surface.

As aforesaid structure, the wrench structure further comprises a positioning member 40, which is in C-shape. The positioning member 40 is stucked in an embedded ring slot 113 under the operating accommodating space110, as a purpose to position the inner member in the operating accommodating space 110. One punch hole 41 is located on the ring on each side of the positioning member 40, which is to conveniently for positioning and operating the shifting.

As aforesaid structure, the wrench structure further comprises a retaining member 115 that is located on an inner side surface of the operating accommodating space 110 and stucked with the corresponding female-connecting member 20.

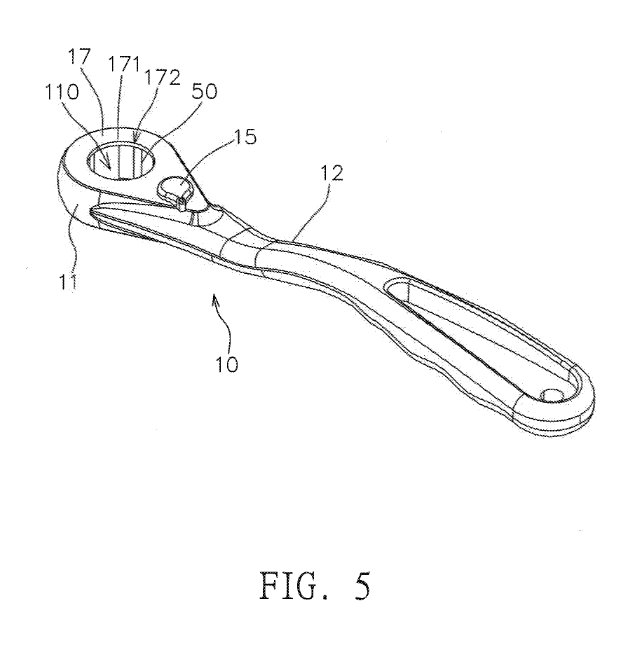

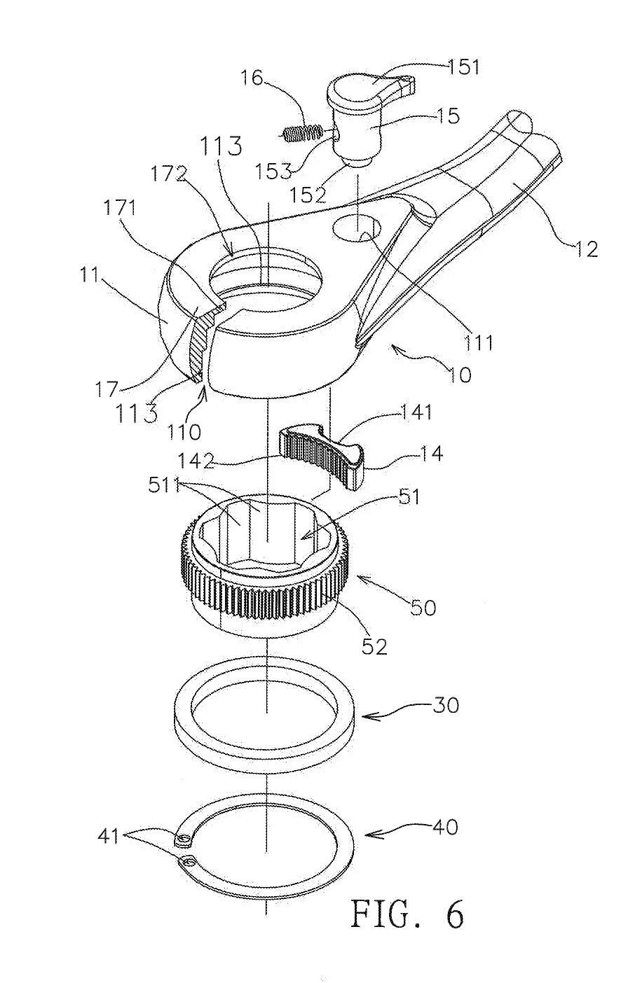

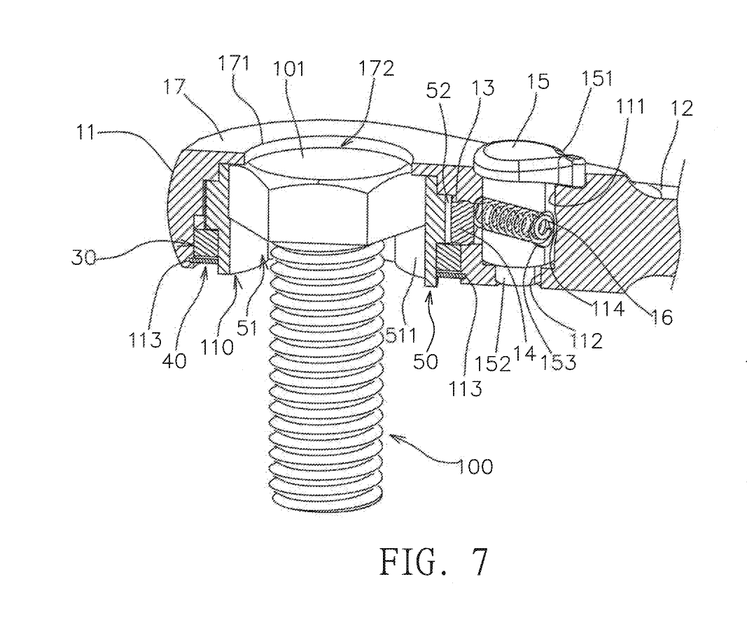

Please refer to FIG. 5 to FIG. 7, which illustrate a schematic 3-dimensional view of a third preferred embodiment of the present invention, a schematic exploded view of the third preferred embodiment of the present invention and a schematic sectional view of operation of the third preferred embodiment of the present invention. The third preferred embodiment is an extended application based on the top end portion 17 of the first preferred embodiment in order to be adapted to ratchet wrench, and comprises a wrench 10, the wrench 10 has a wrench head 11 and a wrench handle portion 12. The wrench head 11 has a hollow operating accommodating space 110, a ring slot 113 at a lower portion of the operating accommodating space 110, a rear portion of the wrench head 11 adjacent to the wrench handle portion 12 (which means the rear portion of the wrench head portion 11) with a first pivotal slot 111, a second pivotal slot 112 with a smaller diameter than the first pivotal slot below the first pivotal slot 111 according to FIG. 7, and the first pivotal slot Iii connected with the operating accommodating space 110 via a horizontal control space 13. In addition, a rear end wall of the first pivotal slot 111 is set with an urging slot 114; as in other embodiments, the first pivotal slot 111 can be disclosed on the wrench handle portion 12, but it depends on the configuration of the wrench head 11; a latching member 14, which is located in the control space 13 and is in a crescent shape, a front end surface of the latching member 14 corresponding to the operating accommodating space 110 is a gear portion 142 and a rear end surface of the latching member 14 is a latching slot 141, the gear portion 142 being shaped as an inner arc, wherein the latching slot 141 is corresponding to the first pivotal slot 111; a reversing switch 15, which is in a pillar shape and is located in the first pivotal slot 111, an upper portion of the reversing switch 15 is a twisting member 151 and a lower portion of the reversing switch 15 is a positioning pillar 152. The twisting member 151 of the reversing switch 15 is mainly in a pillar shape as driving lever, in order to conveniently drive the reversing switch 15. A front surface of the reversing switch 15 has a spring slot 153, while the positioning pillar 152 is located in the second pivotal slot 112 with smaller diameter than the first pivotal slot and the second slot 112 is below the first pivotal slot 111 so as to stabilize the operations of the reversing switch 15; an urging spring 16, which is in the spring slot 153 of the reversing switch 15 and is against the latching slot 141 of the latching member 14 at the front portion thereof and the urging slot 114 of the first pivotal slot 111 is at the rear portion thereof. Generally speaking, the front and rear portions of the urging spring 16 may be equipped with denser springs for enforcement, and the middle portion of the urging spring 16 may have looser springs for providing more flexible forces; besides, each of two end portions of the urging spring is preferably shaped as in arc shape for shifting and urging; a ratchet member 50, which is located in the operating accommodating space 110 of the wrench head 11 and is a hollow gear ring body of the ratchet member accommodating space 51, the ratchet member 50 has an outer gear portion 52 and an inner operating surface 511, wherein the inner operating surface 511 is a combination of arc surface, curved surface or straight surface, and the outer gear portion 52 and the gear portion 142 of the latching member 14 are stacked with each other.

Similarly, a top end portion 17 is above the wrench head 11; a top protruding portion 171 of the top end portion 17 circularly protrudes toward the center of the operating accommodating space 110 and the ratchet member accommodating space 51, the top protruding portion 171 forms an urging ring space 172 that is internally protruded toward the center of the ratchet member accommodating space 51 and is above the ratchet member accommodating space 51, the top protruding portion 171 is a shielding limit of the ratchet member accommodating space 51, in addition, the top end portion 17 is part of the wrench head 11, hence, the top protruding portion 171 is the integrated portions of the wrench head 11, wherein the diameter of the urging ring space 172 is smaller than the diameter of the ratchet member accommodating space 51, so as to reach the block function of the top protruding portion 171; a support ring member 30, which is located in the operating accommodating space 110 and is female-connected with a lower portion of the outer gear ring portion. 52 of the ratchet member 50 in order to support the ratchet member 50; a positioning member 40, which is a c-shaped member and is embedded in a ring slot 113 at a lower portion of the operating accommodating space 110 in order to urge and support the support ring member 30, so as to be a role of totally positioning the elements in the support ring member 110, wherein each of two ends of the positioning member 40 has a ring with a through hole 41 for conveniently positioning and moving operations.

The integrated wrench structure for preventing departed workpieces provided by the present invention can switch a rotation direction via the reversing switch 15. While driving the reversing switch 15, the urging spring 16 is driven to move as well. For the front portion of the urging spring 16, the front portion moves to the two ends of the latching slot 141 of the latching member 14 for front urging, further, for the rear portion of the urging spring 16, the rear portion moves to the urging slot 114 for rear urging, so that the rotation operating direction of the ratchet member 50 is controlled by the movements of the latching member 14 and the urging spring 16.

The integrated wrench structure for preventing departed workpieces provided by the present invention has the wrench head 11 integrated with the top protruding portion 171. The top protruding portion 171 is an upper shielding limit of the operating accommodating space 110 (female-connecting member accommodating space 21 and ratchet member accommodating space 51). Hence, while rotating the workpieces 100 (threaded rod, nut, etc.) in the operating accommodating space 110 (female-connecting member accommodating space 21 and ratchet member accommodating space 51), the top protruding portion 171 of the wrench head 11 is able to cover the head 101 of the workpiece 100 in order to prevent the head of the workpieces 101 from departing upwardly off the urging ring space 172. Therefore, the structure for preventing departed workpieces provided by the present invention is simple, difficult to break or to be deformed, so as to prevent breaking off.

Accordingly, the aforementioned structure is easily assembled by a simple structure in order to prevent breaking off while operating the wrench and workpieces. On the other hand, the present invention is able to lower costs of manufacture and assembly and is able to improve stability and reliability of products.

What is claimed is:

1. An integrated wrench structure for preventing departed workpieces, comprising:
a wrench head (11), having a hollow operating accommodating space (110), a peripheral wall of the operating accommodating space (110) having an operating surface (18), a rear end of the wrench head (11) connecting with a wrench handle portion (12), a top end portion (17) being above the wrench head (11), a top protruding portion (171) of the top end portion (17) circularly protruding toward the center of the operating accommodating space (110), the top protruding portion (171) forming an urging ring space (172) that is internally protruded toward the center of the operating accommodating space and is above the operating accommodating space (110), the urging ring space (172) being a shielding limit of the operating accommodating space (110), the top protruding portion (171) being the integrated portions of the wrench head (11).

2. The integrated wrench structure for preventing departed workpieces according to claim 1, wherein the operating surface (18) is a combination of arc surface, curved surface or straight surface.

3. The integrated wrench structure for preventing departed workpieces according to claim 1, wherein the diameter of the urging ring space (172) is smaller than the diameter of the operating accommodating space (110).

4. An integrated wrench structure for preventing departed workpieces, comprising:
a wrench head (11), having a hollow operating accommodating space (110), a rear end of the wrench head (11) connecting with a wrench handle portion (12), a top end portion (17) being above the wrench head (11);
a female-connecting member (20), being separatable and located in the operating accommodating space (110) and being a hollow ring body of a female-connecting member accommodating space (21), an inner side of the female-connecting member (20) has an operating surface (211);
a top end portion (17) being above the wrench head (11), a top protruding portion (171) of the top end portion (17) circularly protruding toward the center of the female-connecting member accommodating space (21), the top protruding portion (171) forming an urging ring space (172) that is internally protruded toward the female-connecting member accommodating space and is above the female-connecting member accommodating space (21), the top protruding portion (171) being a shielding limit of the female-connecting member accommodating space (21), the top protruding portion (171) being the integrated portions of the wrench head (11).

5. The integrated wrench structure for preventing departed workpieces according to claim 4, wherein the female-connecting member (20) has an outer gear ring portion (22).

6. The integrated wrench structure for preventing departed workpieces according to claim 5, wherein the wrench structure further comprises a positioning member(40) that is stucked in an embedded ring groove(153) under the operating accommodating space(110). One punch holes(41) is located at the ring on each side of the positioning member(40).

7. The integrated wrench structure for preventing departed workpieces according to claim 5, wherein the wrench structure further comprises a retaining member (115) that is located on an inner side surface of the operating accommodating space (110) and stuck with the corresponding female-connecting member (20).

8. The integrated wrench structure for preventing departed workpieces according to claim 4, wherein the diameter of the urging ring space (172) is smaller than the diameter of the female-connecting member accommodating space (21).

9. An integrated wrench structure for preventing departed workpieces, comprising:
a wrench head (11), having a hollow operating accommodating space (110), a rear portion of the wrench head (11) having a first pivotal slot (111), the first pivotal slot (111) being connected with the operating accommodating space (110) via a horizontal control space (13), a rear end of the wrench head (11) connecting with a wrench handle portion (12);
a latching member (14), being located in the control space (13);
a reversing switch (15), being located in the first pivotal slot (111), an urging spring (16) being in the reversing switch (15) and being against the latching member (14);
a ratchet member (50), being located in the operating accommodating space (110) and being a hollow gear ring body of a ratchet member accommodating space (51), the ratchet member (50) having an outer gear portion (52) and an inner operating surface (511), the outer gear portion (52) and the latching member (14) links with each other;
a top end portion (17) being above the wrench head (11), a top protruding portion (171) of the top end portion (17) circularly protruding toward the center of the operating accommodating space (110), the top protruding portion (171) forming an urging ring space (172) that is internally protruded toward the center of the ratchet member accommodating space (51) and is above the operating accommodating space (110) and the ratchet member accommodating space (51), the urging ring space (172) being a shielding limit of the ratchet member accommodating space (51), the top protruding portion (171) being the integrated portions of the wrench head (11).

10. The integrated wrench structure for preventing departed workpieces according to claim 9, wherein a second pivotal slot (112) with a smaller diameter than the first pivotal slot (111) is below the first pivotal slot (111), a rear end wall of the first pivotal slot (111) being an urging slot (114).

11. The integrated wrench structure for preventing departed workpieces according to claim 9, wherein a front end surface of the latching member (14) is a gear portion (142) and a rear end surface of the latching member (14) is a latching slot (141), the gear portion (142) being shaped as an inner arc.

12. The integrated wrench structure for preventing departed workpieces according to claim 10, wherein an upper portion of the reversing switch (15) is a twisting member (151) and a lower portion of the reversing switch (15) is a positioning pillar (152), the positioning pillar being in the second pivotal slot(112).

13. The integrated wrench structure for preventing departed workpieces according to claim 9, wherein a front surface of the reversing switch (15) has a spring slot (153) that accommodates the urging spring (16).

14. The integrated wrench structure for preventing departed workpieces according to claim 9, wherein the diameter of the urging ring space (172) is smaller than the diameter of the ratchet member accommodating space (51).

15. The integrated wrench structure for preventing departed workpieces according to claim 9 further comprising a support ring member (30) that is located in the operating accommodating space (110) and is female-connected with a portion under the gear portion (52) of the ratchet member (50).

16. The integrated wrench structure for preventing departed workpieces according to claim 15 further comprising a positioning member (40) that is embedded in a ring slot (113) in order to urge and support the support ring member (110), wherein the ring slot (113) is at a lower portion of the operating accommodating space (110) and each of two ends of the positioning member (40) has a punch hole (41).
